(19) United States
(12) Patent Application Publication
(10) Pub. No.: US 2013/0238168 A1
(43) Pub. Date: Sep. 12, 2013

(54) VEHICLE CONTROL AND INTERFACE WITH MOBILE DEVICE

(71) Applicant: Jerome Reyes, Stanwood, WA (US)

(72) Inventor: Jerome Reyes, Stanwood, WA (US)

(21) Appl. No.: 13/789,648

(22) Filed: Mar. 7, 2013

Related U.S. Application Data
(60) Provisional application No. 61/608,104, filed on Mar. 7, 2012.

(51) Int. Cl. B64C 19/00

(52) U.S. Cl. CPC B64C 19/00
USPC 701/2

(57) ABSTRACT

A vehicle control system is described herein that uses a mobile computing device to interface with a remotely operated vehicle. The system provides a link between an existing device with Wi-Fi or other networking to a radio controlled vehicle. The system provides an application that runs on the mobile device and uses the networking facilities of the device to send control information to receiving hardware attached to the vehicle. The system may also provide a receiving module that interfaces with an existing flight control module of the vehicle to allow a vehicle that was not specifically designed to be controlled by a mobile phone to have this capability added. Thus an operator unsophisticated in the flight of remote control vehicles can show up to a job site, deploy the vehicle, and have his or her mobile device guide the vehicle through a flight pattern that captures useful measurements.

### CROSS-REFERENCE TO RELATED APPLICATIONS

The present application claims the benefit of U.S. Provisional Patent Application No. 61/608,104 (Attorney Docket No. ROOFERS002) entitled “VEHICLE CONTROL AND INTERFACE WITH MOBILE DEVICE,” and filed on 2012-03-07, which is hereby incorporated by reference.

### BACKGROUND

Measurements are obtained for a variety of types of purposes, including by contractors bidding on construction work. One area where measurements are useful for determining job costs is in the field of roofing. Currently, measurements are obtained by placing personnel on the roof to manually walk the roof and take measurements. These measurements are later used to draw the roof based off notes, or provided to a paid service to draw the roof (potentially as it existed prior to any damage by using old photographs from satellites or fast moving airplanes from thousands of feet away).

The current method does not give sufficient documentation or accuracy as additions to the roof may have been made since a photo was last taken. The method does not identify current damage and the level of accuracy is insufficient and inconsistent, often leading to estimation errors. Existing photos are of such poor resolution that many features of a roof (e.g., plumbing vents) cannot be seen or accurately measured. Oftentimes the existing database of photos does not offer coverage in rural areas or are sometimes obscured by foliage or shadowing. Contractors and insurance adjustors take risk getting on damaged roofs in order to document the roof and acquire measurements for repairs and replacements of roofs. The existing process is dangerous, time consuming, and often inaccurate.

Remote control vehicles such as helicopters are becoming popular for obtaining aerial pictures and footage of various locations. Drones and other non-occupied flying vehicles are increasingly being used by law enforcement, environmental groups, and hobbyists to provide images from heights that were traditionally very expensive to obtain. One problem with these vehicles is the difficulty of controlling them and the experience necessary to control the vehicle without injuring anyone nearby, without damaging the vehicle itself, and to satisfactorily position the vehicle to obtain the desired information (e.g., images, measurements, and so forth).

### BRIEF DESCRIPTION OF THE DRAWINGS

FIG. 1 is a block diagram that illustrates components of the vehicle control system, in one embodiment.

### DETAILED DESCRIPTION

A vehicle control system is described herein that uses a general-purpose mobile computing device to interface with a remotely operated vehicle, such as a helicopter. The vehicle control system provides a link between an existing device, such as a mobile phone, MP3 player with Wi-Fi or other networking, or other device, to a radio controlled vehicle. In some embodiments, the system provides an application that runs on the mobile device and uses the networking facilities of the device (e.g., Wi-Fi, Bluetooth, 3G, or other communication hardware and software protocols) to send control information to receiving hardware attached to the vehicle. The system may also provide a receiving module that interfaces with an existing flight control module or other hardware of the vehicle. For example, the system may provide a USB dongle or other packaging for a receiving module that can be easily attached to the vehicle. This allows the receiving module to interface with the flight control hardware of the vehicle, and also to communicate using whatever communication protocols are available on the mobile device. This allows a vehicle that was not specifically designed to be controlled by a mobile phone, for example, to have this capability added in a manner that is easy for the operator. Once controllable by a mobile computing device, the problem of controlling the vehicle's flight can be addressed in new ways. For example, the vehicle can be controlled remotely by experts with access to the mobile computing device, or the mobile computing device can store predefined flight patterns and can automate the control of the device with very little or no interaction with an on-site user of the vehicle. Thus an operator unsophisticated in the flight of remote control vehicles can show up to a job site, deploy the vehicle, and have his or her mobile device guide the vehicle through a flight pattern that captures useful measurements or other information.

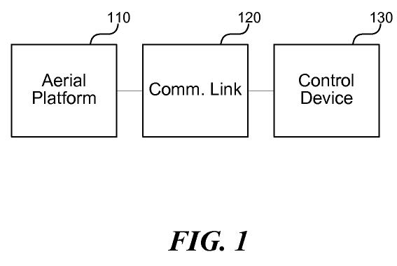

FIG. 1 is a block diagram that illustrates components of the vehicle control system, in one embodiment. The components include an aerial platform 110, a communications link 120, and a control device 130. The aerial platform 110 may include a remotely controllable vehicle, such as a quadcopter, helicopter, or airplane. The communications link 120 may include Wi-Fi or other networking technologies, along with appropriate transmitting and receiving equipment. The control device 130 may include a mobile computing device carried by an operator of the system, such as a smartphone, tablet, smart watch, or other device.

In some embodiments, it is not necessary that the mobile computing device be separate from the vehicle. For example, embodiments of the vehicle control system may provide a mobile device dock directly in the vehicle itself. In this way, for example, an operator can arrive to a job site, insert his or her mobile device into the vehicle, and allow the vehicle to fly away with the mobile device on board to capture relevant information. In such embodiments, the mobile device provides instructions for controlling the flight path while onboard the vehicle. The system may optionally provide a separate device that remains with the operator to operate as a kill switch in the event of a malfunction of the vehicle. Upon activating the kill switch, the vehicle may gently set itself down or return to the operator's last location.

Control through the mobile computing device may use a variety of interesting methods of input for determining a flight pattern. In some embodiments, the vehicle control system receives voice commands to direct the flight of the vehicle. Voice command is a technique that is easier for users to understand and use, making the system user friendly. Smartphones and other mobile devices are increasingly incorporating some level of voice commands and voice recognition at the operating system level. For example, Apple's iPhone platform includes Siri and Google's Android platform includes native voice recognition. The vehicle control system can leverage these facilities to receive voice commands for flight control. A mobile application associated with the system can receive voice commands, determine which available flight control is implied by the commands, and deliver the flight control information to the vehicle for determining the pattern of flight. Voice commands may include low level commands, such as “pitch left” or “increase rotor speed”, or may include high level commands, such as “go to 100 feet altitude” or “fly 100 feet north”. These and other commands can be determined by any particular implementation of the system, the system provides the link between the capabilities of the mobile device and flight control hardware of the vehicle.

In some embodiments, the vehicle control system receives other audio input for flight control. Interestingly, because of the propeller speed and other characteristics of flying remote controlled vehicles, their operation carries a particular sound signature. In fact, it is possible to determine how far away a vehicle is from a microphone based on attributes such as the amplitude and frequency/pitch of the incoming sound. It is possible to accurately position a vehicle based on audio input. In this manner, the vehicle control system may receive as input prerecorded audio information that conveys a desired flight pattern of the vehicle. A system implementer can provide audio information for particular common flight patterns, such as flying up 100 feet, making a 100-foot diameter circle, and returning to the original location. The audio information may be prerecorded and provided to the user's mobile device via a download or through other methods well known in the art.

During flight, the vehicle may capture video, images, audio, or other information from sensors attached to the vehicle. In the case of measurement, the vehicle may be used to capture a photograph of various angles of a roof, to survey an area damaged by storm, and so forth. The communication interface between the vehicle and the mobile device may also be used to download this captured information for further use, such as uploading to an estimation service or delivery to a contractor. For example, the system may send captured images to a user's smartphone where the user can then download the images to a desktop computer, email the images to other users, and so forth. In some embodiments, a mobile application associated with the system operates to make the capture and upload of information at a particular site as trouble free for the user as possible. The user may simply show up at the job site, set the vehicle on the ground, wait while the mobile application guides the vehicle through a flight pattern to capture information, and then pack the vehicle away to leave. During this time, the application may have already uploaded captured information to a central office or other facility where the information is analyzed.

The vehicle control system may provide various channels that can be used between the mobile application and receiving module to control the vehicle in various ways. For example, if the system provides four channels and the vehicle is a helicopter, then one channel may be used for throttle, another for rotor angle, and another for tail rotor throttle. A fourth channel may turn on and off camera equipment attached to the vehicle or perform other functions.

The predominate method for controlling remote control quadcopters, helicopters, and airplanes today is via radio channels, the most common channels being 2.4 GHz and 5.8 GHz. This allows for significant range (up to a mile or more) depending on the strength of the transmitter. Wireless control can also be achieved via a Wi-Fi signal. This presents significant challenges with range as most Wi-Fi networks are typically 100 feet line of site or less. In some embodiments, the vehicle control system described herein allows a user to switch between the two or combine the two or use one exclusively. The system also allows the user to use a third technology, cellphone technology (e.g., GSM, CDMA, or similar), to communicate with the vehicle. The system allows the user to utilize a smartphone/tablet/pad/pc to control the vehicle and potentially extend their range by utilizing a radio channel like 2.4 GHz. There is sufficient bandwidth with all three of these mediums to also communicate photography or video from the vehicle that can be used for a number of purposes like measurements, tracking, verification, identification, and so on.

In some embodiments, the vehicle control system includes firmware or other updateable, stored instructions that can be modified to add new features, correct errors, or program the system for particular modes of operation. The system has plug and play capability when an end user requests it and provides the drivers for camera/radio transmitters/Wi-Fi antennae and cellular technology.

The following paragraphs describe one vehicle system, referred to as the remote measurement system, to which the vehicle control system can be applied.

A remote measurement system is described herein that provides extremely accurate real-time data for a roof or other object, without requiring placing personnel in danger. The acquired data may include photos, laser mapping, thermal images, sonar imaging, or other types of measurement data. In some embodiments, the system leverages commonly available remote control helicopters or other flying vehicles mounted with a camera or other equipment to acquire images or other measurement data that would be difficult to obtain without climbing or placing personnel in other dangerous situations. In recent years, several self-stabilizing remote control helicopters have become cheaply available, and some even offer control via a smartphone using Bluetooth, Wi-Fi, or other remote connections. An aerial platform is described herein that can include such helicopters, as well as other types of remote measurement devices, such as laser measurers, remote cameras, and so forth. In many cases, these connected devices can provide near instant availability of captured data to a processing center or other remote location, reducing delays that are typical today. The following steps describe one example process for acquiring measurement data using the remote measurement system. The steps include preparation, link, flight, data transfer, processing, and product delivery, each described further in the following sections.

### Preparation

The preparation step includes the acquisition of information by the end user (e.g., a contractor, homeowner, insurance adjustor, or roof consultant) to determine whether or not conditions (e.g., rain, wind, hail, etc. . . . ) are within the flight parameters of the aerial platform and whether there is sufficient space for a safe takeoff and landing of the aerial platform. In some embodiments, the aerial platform includes any remote controlled aircraft capable of carrying a payload of a digital camera or other sensors and stable hovering flight.

### Link

The link step includes the action of acquiring a connection between the aerial platform, the end user, and a centralized base location where acquired data can be processed (or any combination of the three). This step may be performed through any means of transmitting information known in the art, such as through a verbal signal, a written signal (e.g., a letter), an electronic signal (e.g., email), a visual signal (e.g., video monitor), and so on. The link allows for the transfer of data and may be used to remotely control the flight of the aerial platform by providing parameters and waypoints for images to be taken. For example, in one embodiment an operator may point a laser sight at significant points of a roof, registering each point with software running on a mobile phone as a point of interest for a photograph or other capture of measurement data. The software may develop a flight plan automatically and direct the aerial platform to the registered points, or may allow the operator to fly the platform manually.

The link may include various types of connections, such as a Wi-Fi connection between the aerial platform and a control device (e.g., a remote or smartphone) carried by the operator, a 3G connection between the control device and a base station, and so on. Those of ordinary skill in the art will recognize a wide variety of available types of connections for sharing data and commands between the operator, aerial platform, and base station.

More recent regulations related to small flight vehicles, such as quadcopters, make Wi-Fi and other short range networking technologies ideal for controlling a vehicle at a location. For example, one regulation in the United States limits the height limit to which these vehicles can be legally operated to approximately 400 feet. In an open space, Wi-Fi can achieve this range with appropriately powered transmitting and receiving hardware as can other network technologies.

### Flight

Flight describes the operation of the aerial platform from takeoff to landing and the acquisition of aerial photos and other data at specified locations. In some embodiments, the system automatically selects an altitude of the aerial platform at which photos taken will show the entirety of the subject (e.g., a roof), but from as close as possible to capture the most detail possible (e.g., less than 500 feet above ground level). In some jurisdictions, regulatory rules may limit the flight pattern of the aerial platform, and the control software can be configured to adhere to such rules. The flight can be manually controlled by the end user, remotely controlled by base, automatically controlled by software with pre-programmed global position system (GPS) waypoints, or a hybrid of any combination of these.

In some embodiments, the aerial platform may include sensors that automate part or all of the flight. For example, the platform may include sensors for avoiding obstacles, sensors for identifying and positioning around the subject, sensors for determining how large the subject is and where to position the platform, and so forth. Robotics and object recognition have improved to the point that it is possible through software and input (such as from cameras, microphones, infrared sensors, and so on) to automate flight around a subject and rapidly capture information at specified waypoints.

### Data Transfer

Data Transfer describes the ongoing transfer of data between any parts of the system, such as the aerial platform, an operator controller, and a base station. The software that links the aerial platform and base can be used to control the flight, transfer photos acquired before, during, and after flight as well as information deemed pertinent by the end user and base.

The system can be implemented in a variety of ways. In some embodiments, an operator goes to a site with the aerial platform. During the site visit, the operator communicates with the aerial platform via a controller, which can include a device already carried by the operator, such as a smartphone. Upon leaving the site and returning to the operator's office or other location, the operator can dock the aerial platform to upload the captured measurement data.

In other embodiments, the aerial platform and/or operator controller communicate with a central processing center remotely while in the field. This allows the information to be provided to the processing much faster and allows feedback to the operator while still at the job site. For example, an analyst at the processing center may determine that further images would be helpful, and may send a message to the operator requesting additional images or the analyst may direct the aerial platform to capture the images himself.

### Processing

Processing describes the manipulation of the data either manually by a person or automatically with software (or a combination thereof) to provide the desired product to the end user. In some embodiments, the system uses aerial photos captured by the aerial platform along with diagramming software to accurately measure and report the total linear measurements of roof features. The diagramming software may include methods for determining the pitch of a roof in a photo so that the software can identify and measure ridges, rakes, valleys, hips, gutters, and area measurements of different fields of a roof and the totals of all measurements along with pitches and roof penetrations including but not limited to skylights, chimneys, plumbing ventilation, and solar panels. Automated processing of this type can be completed rapidly upon receipt of the photographic input data from the aerial platform in the field.

The processing step may include various levels of human and machine interaction. For example, software may provide initial measurement output that an analyst then verifies and either approves or modifies before approving. For example, the analyst may check whether the software correctly identified each of the roof features. In some embodiments, the system automatically tunes itself based on analyst feedback to improve subsequent automatic recognition of features and related measurements.

### Product Delivery

Product delivery describes the delivery of a product to the end user, such as a report, contract bid, or other output from the system. In some embodiments, the remote measurement system includes a web site through which users interact with the system to place an order and receive output in response to the order. For example, a user may visit the website and provide an address of a location of the user's home that needs a roof, as well as other information such as contact information, scheduling information, and so forth. The system dispatches an operator with an aerial platform to the user's location, where the operator uses the aerial platform to capture data about the user's roof without climbing up on the roof himself. The aerial platform uploads information to the processing center, which analyzes the captured information to create a model of the work to be performed. Bidding software then creates a bid based on the model, and provides the bid as output to the user. The system may send the user an email, text message, or other notification when the output is available. The entire process can be completed in a matter of days, helping users, contracts, and others obtain fast access to detailed information for accomplishing their goals.

The steps described above may occur in the order shown or may be reordered in some implementations to achieve similar results. For example, the link step may occur before the preparation step, and the data transfer step may occur at several stages of the process (e.g., initially to dispatch the operator, in the middle to capture flight data, and later to send output information to the user).

### Aerial Platform

As discussed above, the remote measurement system includes an aerial platform with sensors for capturing data that may include a variety of types of common or custom-made devices. For example, the devices may include controlled flyers, hot air balloons, long poles, helicopters, gliders, unmanned aerial vehicles (UAVs), or any other type of remotely controllable vehicle. The device may be equipped with a variety of sensors for capturing useful measurement data, including digital photos, laser mapping and/or measurements, thermal images, sonar mapping, and so on.

The aerial platform may also include a variety of control technologies. For example, the platform may include automated control software, such that very little external input is received after programming an initial plan, or the platform may include a controller for manually controlling the platform. The controller may include a dedicated remote control, a smartphone running control software and connected via a communication link, and so forth. For example, an operator may use an Apple iPhone application to program a flight pattern using global positioning system coordinates as waypoints at which the aerial platform will acquire data that the application may automatically transfer to the base server for processing. The controller, aerial platform, and base may communicate using wired or wireless communication (e.g., Bluetooth technology, infrared signals, radio signals, laser signals, 3G, 4G, or any other wired or wireless means of communication). The system may provide the operator with a live connection with the base during and after the flight to confirm receipt of data (e.g., a phone connection, instant messaging, or similar). This software application may identify the specific operator requesting the flight and all of the operator's contact and billing information as well as email address for report delivery may be identified.

In some embodiments, the aerial platform operator and processing center may be run by separate entities. For example, the processing center may contract with one or more operators to be available for dispatch to locations, and the operator may maintain expertise in capturing measurement data using the aerial platform and providing the information to the processing center. In some cases, the processing center may provide a measurement kit to a homeowner or other end user that the end user can request for remotely capturing and uploading data to the processing center. In other cases, a roofing contractor or similar subject matter expert may use the system to take on-site to potential job sites and may contract with the processing center to provide automated processing of captured information to determine measurements and other information from which the expert can generate a bid.

In some embodiments, the aerial platform itself contains software for analyzing captured data and calculating measurement data from the captured data. The aerial platform may provide the ability to output information, such as a three-dimensional model or other visualization, to a nearby device (e.g., a monitor or printer). In such cases, the platform may operate without a central processing facility or the facility may provide a different role (e.g., billing, capturing customer data, and so forth) and be less involved with data capture and processing.

In some embodiments, the aerial platform provides first person viewing (FPV) of the flight by the operator with a video monitor, glasses, a smartphone display, or other viewing device. The platform may also include a “return to home” function as a safety measure should the need arise to take control of the aerial platform locally and have the aircraft immediately return to the spot it was launched. Power sources for the aerial platform may include battery, solar, wired, or laser powered flight. A laser can be used to control the movement of flight as well as photograph functions.

In some embodiments, the aerial platform operates independently and includes an information output device (such as a monitor or display), an information input device (such as a mouse, keyboard, touchpad, or microphone), and the mechanical means to fly autonomously. This device includes sufficient computing power to capture aerial photos, perform edge detection, and create a model of the structure with scaled measurements for pertinent features. The platform may then send this information via email or other communication mechanism to the end user.

### CONCLUSION

The remote measurement system can be used to provide a consumer the ability to safely view and measure a wide variety of building exterior components such as roofs, gutters, siding, windows, fencing, landscaping, and parking lots. The system can also be used in other industries such as farming, security, fishing, hunting, military, law enforcement, firefighting, and large incidents (such as natural disasters). Systems of measurement, estimating, evaluating, and reconnoitering can leverage the remote measurement system. Real estate evaluation, advertising, city planning, and building department enforcement, as well as fish and wildlife department inspections departments can benefit from the system as well as lifeguarding, railroad safety, and construction project management.

The remote measurement system provides near instantaneous data to the end user, provides documentation, and provides aerial perspective at a much lower cost to the end user than what is currently available.

From the foregoing, it will be appreciated that specific embodiments of the system have been described herein for purposes of illustration, but that various modifications may be made without deviating from the spirit and scope of the invention. Accordingly, the invention is not limited except as by the appended claims.

I/We claim:

1. A system as substantially shown and described herein, and equivalents thereof.

2. A method as substantially shown and described herein, and equivalents thereof.
